(19) United States
(12) Patent Application Publication
(10) Pub. No.: US 2021/0176833 A1
(43) Pub. Date: Jun. 10, 2021

(54) HEATING COIL AND QUENCHING DEVICE

(71) Applicant: Neturen Co., Ltd., Tokyo (JP)

(72) Inventors: Kazuya KITAO, Tokyo (JP); Shingo DEGUCHI, Tokyo (JP)

(21) Appl. No.: 17/111,622

(22) Filed: Dec. 4, 2020

(30) Foreign Application Priority Data
Dec. 5, 2019 (JP) 2019-220712
Oct. 12, 2020 (JP) 2020-172169

(51) Int. Cl. H05B 6/36; C21D 1/42; C21D 9/40; C21D 1/62; H05B 6/10

(52) U.S. Cl. CPC H05B 6/36; C21D 1/42; H05B 6/101; C21D 1/62; C21D 9/40

(57) ABSTRACT

To provide a heating coil and a quenching device that are capable of stably forming an unquenched region at an opening side end of a roller guide groove, and to reduce the manufacturing cost of a tripod type constant velocity joint and its outer ring.

A heating coil of a quenching device includes: a coil body; and a plurality of shield members, wherein the coil body includes three heaters each housed in a roller guide groove of an outer ring of a tripod type constant velocity joint, and three connectors, the heater has a first heating conductor and a second heating conductor, the connector has a first connection conductor and a second connection conductor, the shield member is provided for each of the connectors, and is disposed between the first connection conductor and the second connection conductor of the connector, and a circumferential interval between the first connection conductor and the second connection conductor of the connector is larger than a circumferential interval between the second heating conductor of one heater of the two heaters adjacent to each other in the circumferential direction and the first heating conductor of the other heater.

### BACKGROUND

### Technical Field

An embodiment relates to a heating coil used for induction heating of a roller guide groove formed on an inner peripheral surface of an outer ring of a tripod type constant velocity joint, and a quenching device including the heating coil.

### Related Art

A tripod type constant velocity joint with variable transmission distance is known as a type of constant velocity joint that performs power transmission between two shafts having a crossing angle. The tripod type constant velocity joint includes an outer ring and a shaft. An inner peripheral surface of the outer ring is provided with three axially extending roller guide grooves. The tip of the shaft is provided with three radially projecting short shafts, and a roller is mounted on each short shaft. The tip of the shaft is inserted into the outer ring, and each roller is housed in the roller guide groove. When the roller slides in the roller guide groove, the transmission distance is changed.

In order to increase the surface hardness of the roller guide groove that is in sliding contact with the roller, the roller guide groove is quenched in some cases, and the heating at the time of quenching is performed by high-frequency induction heating, for example (See JP-UM-A-2-38459 and JP-UM-A-5-54534). In order to avoid the shaft inserted into the outer ring from coming off, for example, a snap ring abutting against the roller is attached to the outer ring. In the tripod type constant velocity joint described in JP-A-11-336782 and JP-A-2006-153135, instead of the snap ring, a projection raised inside the groove is formed at an opening side end of the roller guide groove.

### SUMMARY

As in the tripod type constant velocity joint described in JP-A-11-336782 and JP-A-2006-153135, the projection is formed at the opening side end of the roller guide groove, and the shaft is avoided from coming off by the abutment between the projection and the roller, whereby the snap ring is omitted, and thus it is possible to omit a process of forming, in the outer ring, the groove to which the snap ring is mounted, and to reduce the cost. However, the projection is formed by plastically deforming the material of the opening side end of the roller guide groove. Therefore, when the roller guide groove is quenched, it is necessary to provide an unquenched region at the opening side end.

It is conceivable that in a case where the unquenched region is provided at the opening side end of the roller guide groove, for example, when the roller guide groove is subjected to high-frequency induction heating, temperature rise of the opening side end is suppressed by injecting a cooling liquid to the opening side end of the roller guide groove and/or its vicinity. However, the injection amount of the cooling liquid is small, and it is thus very difficult to stably inject the cooling liquid. Due to the variation in the injection of the cooling liquid, the opening side end and its vicinity are overheated, and the unquenched region is not stably formed, and a defect such as a quench crack can occur.

The embodiment has been made in view of the above circumstances, and its object to provide a heating coil and a quenching device that are capable of stably forming an unquenched region at an opening side end of a roller guide groove.

A heating coil according to an aspect of the invention is a heating coil used for induction heating of a roller guide groove formed on an inner peripheral surface of an outer ring of a tripod type constant velocity joint, including: a coil body inserted into the outer ring through an opening on one end side of the outer ring; and a plurality of shield members disposed to face an inner peripheral surface of an opening side end of the outer ring, wherein the coil body includes three heaters that are disposed at intervals in a circumferential direction around a central axis and each housed in the roller guide groove, and three connectors that are interposed between the two heaters adjacent to each other in the circumferential direction and project from the opening of the outer ring, the three connectors connecting the three heaters in series with a power source, the heater has a first heating conductor and a second heating conductor disposed to face each other on both side surfaces of the roller guide groove, which are a pair of heating conductors extending along the central axis, the connector has a first connection conductor extending from the second heating conductor of one heater of the two heaters adjacent to each other in the circumferential direction and a second connection conductor extending from the first heating conductor of the other heater, which are a pair of connection conductors extending along the central axis, the shield member is provided for each of the connectors, and is disposed in a circumferential gap between the first connection conductor and the second connection conductor of the connector, and a circumferential gap between the first connection conductor and the second connection conductor of the connector is larger than a circumferential gap between the second heating conductor of one heater of the two heaters adjacent to each other in the circumferential direction and the first heating conductor of the other heater.

A quenching device according to an aspect of the invention is a quenching device including the heating coil and a cooling jacket that injects a cooling liquid onto an inner peripheral surface of the outer ring in which the roller guide groove is subjected to induction heating by the heater of the heating coil, in which the roller guide groove is subjected to induction heating in a state where a positional relationship between the heating coil and the outer ring is fixed.

According to an embodiment of the invention, it is possible to provide a heating coil and a quenching device that are capable of stably forming an unquenched region at an opening side end of a roller guide groove, and to reduce the manufacturing cost of a tripod type constant velocity joint and its outer ring.

### BRIEF DESCRIPTION OF DRAWINGS

FIG. 1 is a cross-sectional view of an example of a tripod type constant velocity joint for explaining an embodiment of the invention;

FIG. 2 is a plan view of the outer ring of FIG. 1;

FIG. 3 is a schematic view of a quenching device used for quenching of a roller guide groove of the outer ring of FIG. 1;

FIG. 4 is a perspective view of a coil body of a heating coil of the quenching device of FIG. 3;

FIG. 5 is a bottom view of the heating coil of FIG. 4;

FIG. 6 is a bottom view of the coil body of the heating coil of FIG. 4;

FIG. 7 is a schematic view showing the flow of the induction current flowing through the outer ring that is subjected to induction heating by the heating coil of FIG. 4;

FIG. 8 is a schematic view showing a quenching pattern of the outer ring quenched using the heating coil of FIG. 4;

FIG. 9 is a plan view of the outer ring of an experiment example; and

FIG. 10 is a schematic view of the heating coil of some of the experiment examples.

### DETAILED DESCRIPTION

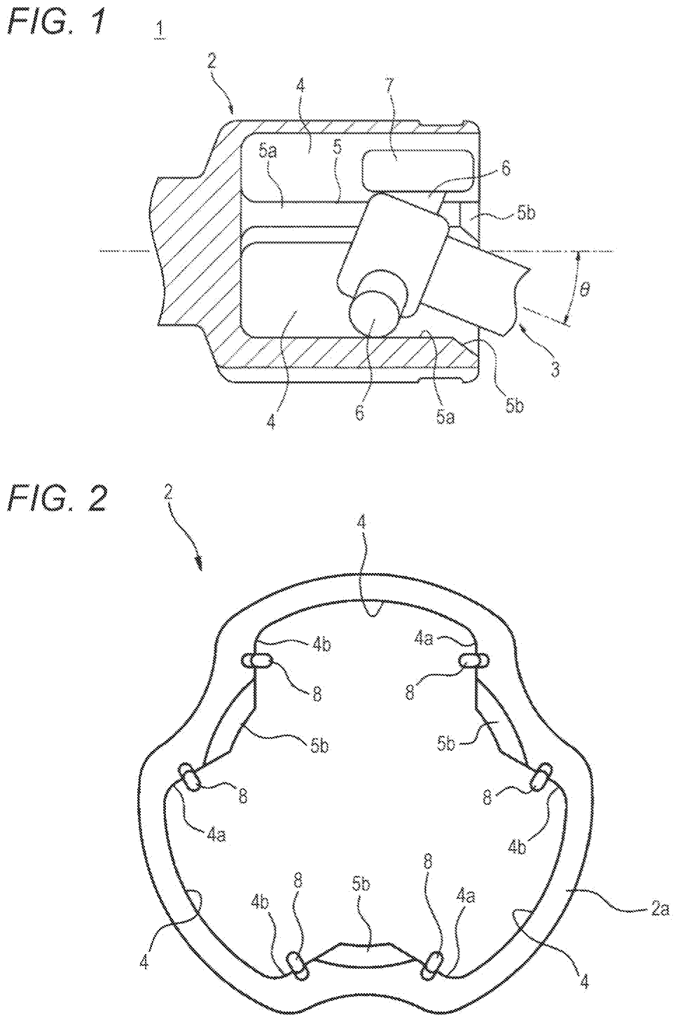

FIGS. 1 and 2 show an example of a tripod type constant velocity joint for explaining an embodiment of the invention.

A tripod type constant velocity joint (Hereinafter referred to as a constant velocity joint.) 1 includes an outer ring 2 and a shaft 3. The constant velocity joint 1 is used for power transmission between an input side differential and an output side drive shaft in a vehicle such as an automobile. The outer ring 2 is connected to the differential, and the shaft 3 is configured as a drive shaft.

The outer ring 2 has an opening at one axial end side. The inner peripheral surface of the outer ring 2 is provided with three roller guide grooves 4 and three protrusions 5. The three roller guide grooves 4 are disposed circumferentially at intervals of 120°, and axially extend from an opening end surface 2a of the outer ring 2. The three protrusions 5 axially extend from the opening end surface 2a of the outer ring 2 between the two circumferentially adjacent roller guide grooves 4.

The shaft 3 has three short shafts 6 at the tip. The three short shafts 6 are circumferentially disposed at intervals of 120°, and radially project from the tip of the shaft 3. A roller 7 is mounted on each short shaft 6. The tip of the shaft 3 is inserted into the outer ring 2, and the roller 7 is housed in the roller guide groove 4. The roller 7 can slide both side surfaces 4a and 4b of the roller guide groove 4 in the extending direction of the roller guide groove 4.

The short shaft 6 rotatably supports the roller 7, and permits the inclination of the rotation axis of the roller 7 with respect to the central axis of the short shaft 6 to support the roller 7. A crossing angle θ is set between the central axis of the outer ring 2 and the central axis of the shaft 3 with the inclination of the rotation axis of the roller 7. From the viewpoint of expanding the settable crossing angle θ, a chamfer surface 5b inclined so as to expand the opening of the outer ring 2 is formed at the opening side end of the protrusion 5.

As the roller 7 slides on the both side surfaces 4a and 4b of the roller guide groove 4, the transmission distance (e.g., the distance between the differential and the drive shaft) is changed. The both side surfaces 4a and 4b of the roller guide groove 4 in sliding contact with the roller 7 are quenched, and the surface hardness of the both side surfaces 4a and 4b is increased. A surface 5a of the protrusion 5 circumferentially adjacent to the both side surfaces 4a and 4b is also quenched.

However, the chamfer surface 5b, which is the opening side ends of the both side surfaces 4a and 4b of the roller guide groove 4 and the opening side end of the surface 5a of the protrusion 5, is respectively provided with an unquenched region extending to the opening end surface 2a of the outer ring 2. In the unquenched regions of the both side surfaces 4a and 4b, a projection 8 raised toward the inside of the roller guide groove 4 is formed. The projection 8 is formed by driving a pin or the like into the opening end surface 2a of the outer ring 2 along the edge of the both side surfaces 4a and 4b, for example, and plastically deforming the material of the unquenched region of the both side surfaces 4a and 4b. The shaft 3 is avoided from coming off from the outer ring 2 by the projection 8 and the roller 7 abutting against each other.

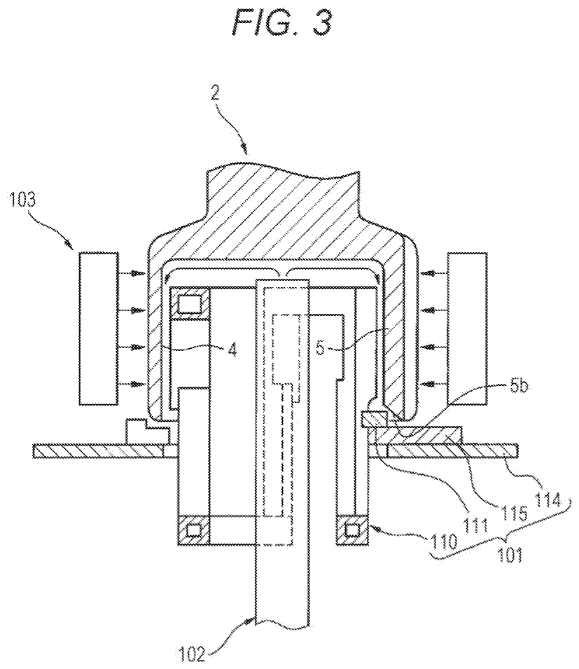

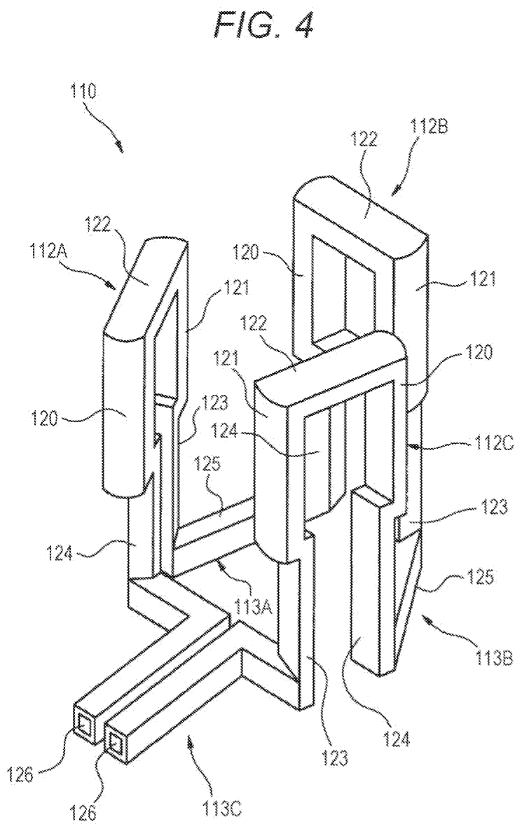

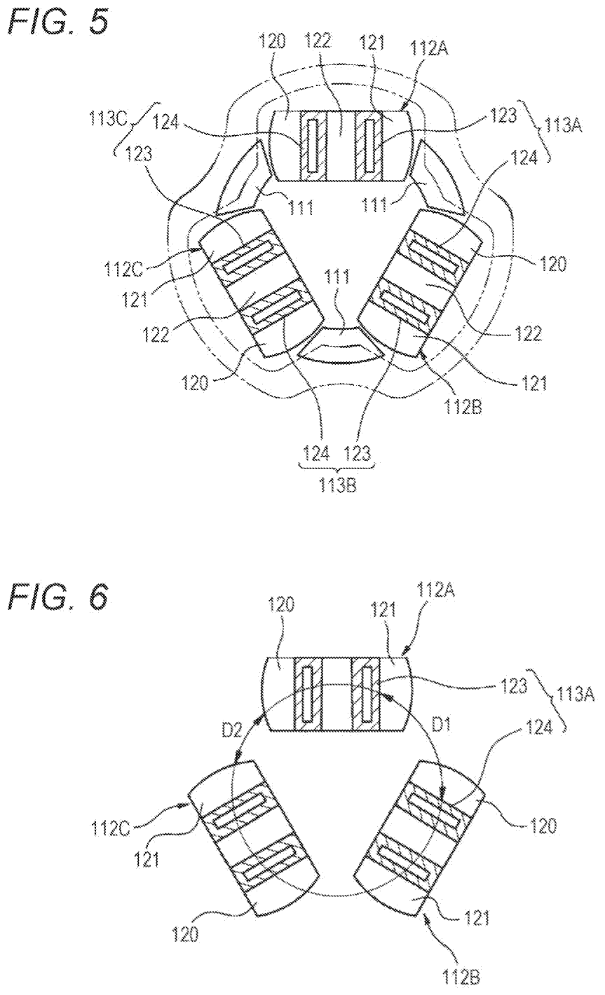

FIGS. 3 to 6 show an example of the quenching device and the heating coil, for explaining an embodiment of the invention.

A quenching device 100 is used for quenching the outer ring 2 of the constant velocity joint 1 described above. The quenching device 100 includes a heating coil 101 and a first cooling jacket 102. The heating coil 101 is inserted into the outer ring 2 through an opening on one end side of the outer ring 2, and subjects the both side surfaces 4a and 4b of the roller guide groove 4 of the outer ring 2 to induction heating. In the first cooling jacket 102, the both side surfaces 4a and 4b are rapidly cooled by injecting a cooling liquid to the inner peripheral surface of the outer ring 2 in which the both side surfaces 4a and 4b of the roller guide groove 4 have been subjected to induction heating by the heating coil 101. Thus, the both side surfaces 4a and 4b are quenched.

The quenching device 100 further includes a second cooling jacket 103. The second cooling jacket 103 injects the cooling liquid to the outer peripheral surface of the outer ring 2 when the heating coil 101 subjects the both side surfaces 4a and 4b of the roller guide groove 4 to induction heating. This avoids the outer ring 2 from burning out. The burning out means that the quenching hardening layer reaches from the inner diameter side to the outer diameter side in quenching of both side surfaces 4a and 4b of the roller guide groove 4.

The quenching device 100 performs induction heating and rapid cooling of the both side surfaces 4a and 4b of the roller guide groove 4 in a state where the positional relationship between the heating coil 101 and the outer ring 2 is fixed. Productivity is excellent compared to the case of performing induction heating and rapid cooling of the both side surfaces 4a and 4b of the roller guide groove 4 while moving the heating coil and the outer ring 2 relatively in the axial direction of the outer ring 2.

The heating coil 101 includes a coil body 110 and a plurality of shield members 111. The coil body 110 has three heaters 112A, 112B, and 112C inserted into the outer ring 2 through an opening on one end side of the outer ring 2, and three connectors 113A, 113B, and 113C projecting from the opening of the outer ring 2. The heaters 112A, 112B, and 112C are disposed around a central axis X of the coil body 110 at intervals of 120°, and when inserted into the outer ring 2, they are disposed in the roller guide groove 4 of the outer ring 2.

The heater 112A has a pair of a first heating conductor 120 and a second heating conductor 121. The first heating conductor 120 extends along the central axis X and is disposed to face one side surface of the roller guide groove 4. The second heating conductor 121 extends along the central axis X and is disposed to face the other side surface of the roller guide groove 4. The tip end of the first heating conductor 120 and the tip end of the second heating conductor 121 disposed on the bottom side of the outer ring 2 are coupled via a bridge conductor 122, and the heater 112A is formed in a U shape as a whole. The heater 112B and the heater 112C also have the first heating conductor 120, the second heating conductor 121, and the bridge conductor 122, and, similarly to the heater 112A, are formed in a U shape as a whole.

The connector 113A has a pair of a first connection conductor 123 and a second connection conductor 124. The first connection conductor 123 extends from the second heating conductor 121 of the heater 112A along the central axis X. The second connection conductor 124 extends from the first heating conductor 120 of the heater 112B along the central axis X. The tip end of the first connection conductor 123 and the tip end of the second connection conductor 124 are coupled via a bridge conductor 125, and the connector 113A is formed in a U shape as a whole. The connector 113A connects the two circumferentially adjacent heaters 112A and heater 112B in series.

The connector 113B has a pair of the first connection conductor 123 and the second connection conductor 124. The first connection conductor 123 extends from the second heating conductor 121 of the heater 112B along the central axis X. The second connection conductor 124 extends from the first heating conductor 120 of the heater 112C along the central axis X. The tip end of the first connection conductor 123 and the tip end of the second connection conductor 124 are coupled via a bridge conductor 125, and, similarly to the connector 113A, the connector 113B is formed in a U shape as a whole. The connector 113B connects the two circumferentially adjacent heaters 112B and heater 112C in series.

The connector 113C has a pair of the first connection conductor 123 and the second connection conductor 124. The first connection conductor 123 extends from the second heating conductor 121 of the heater 112C along the central axis X. The second connection conductor 124 extends from the first heating conductor 120 of the heater 112A along the central axis X. The first connection conductor 123 and the second connection conductor 124 of the connector 113C are connected to a power source, and the heaters 112A, 112B, and 112C are connected in series to the power source via the connectors 113A, 113B, and 113C.

A conductor group (the first heating conductor 120, the second heating conductor 121, the bridge conductor 122, the first connection conductor 123, the second connection conductor 124, and the bridge conductor 125) forming the heaters 112A, 112B, and 112C and the connectors 113A, 113B, and 113C are made of a tubular material and forms a continuous internal flow path 126. A cooling liquid such as water flows through in the internal flow path 126. The coil body 110, which generates heat by energization, is cooled by the cooling liquid flowing through in the internal flow path 126.

A circumferential interval D1 between the first connection conductor 123 and the second connection conductor 124 of each of the connectors 113A, 113B, and 113C is larger than a circumferential interval D2 between the second heating conductor 121 of one heater (e.g., the heater 112C) and the first heating conductor 120 of the other heater (e.g., the heater 112A) among the two circumferentially adjacent heaters (e.g., the heater 112C and the heater 112A).

The shield member 111 is provided for each of the connectors 113A, 113B, and 113C, and is disposed between the first connection conductor 123 and the second connection conductor 124 of each heater. The first heating conductor 120 and the second heating conductor 121 of each of the heaters 112A, 112B, and 112C are shorter than the roller guide groove 4 of the outer ring 2, and housed in the roller guide groove 4. Therefore, the shield member 111 disposed on the base end side of the first connection conductor 123 and the second connection conductor 124 is housed inside the opening side end of the outer ring 2 and disposed to face the chamfer surface 5b of the protrusion 5.

Since the circumferential interval D1 is larger than the circumferential interval D2, there are steps occurring at a junction between the second heating conductor 121 and the first connection conductor 123 and a junction between the first heating conductor 120 and the second connection conductor 124. These junctions may be formed in a stepped shape or a slope shape, for example. The shape of the junction is appropriately set in accordance with the shape of the roller guide groove 4 of the outer ring 2, the shape of the shield member 111 disposed between the first connection conductor 123 and the second connection conductor 124, and the like. The shape of the shield member 111 can also be appropriately set in accordance with the shape of the protrusion 5 of the outer ring 2 or the like, and, for example, since the chamfer surface 5b is inclined, the surface of the shield member 111 facing the chamfer surface 5b may be inclined similarly.

The coil body 110 and the plurality of shield members 111 are supported by a support 114. The support 114 is made of an insulation material such as ceramics. The support 114 further supports the outer ring 2 in this example in which induction heating and rapid cooling of the both side surfaces 4a and 4b of the roller guide groove 4 are performed in a state where the positional relationship between the heating coil 101 and the outer ring 2 is fixed.

The coil body 110 is fixed to the support 114. On the other hand, the shield member 111 is attached to and detached from the support 114 via an appropriate spacer 115. By changing the thickness of the spacer 115, the position of the shield member 111 between the first connection conductor 123 and the second connection conductor 124 changes along the central axis X, and the distance between the shield member 111 and the chamfer surface 5b changes.

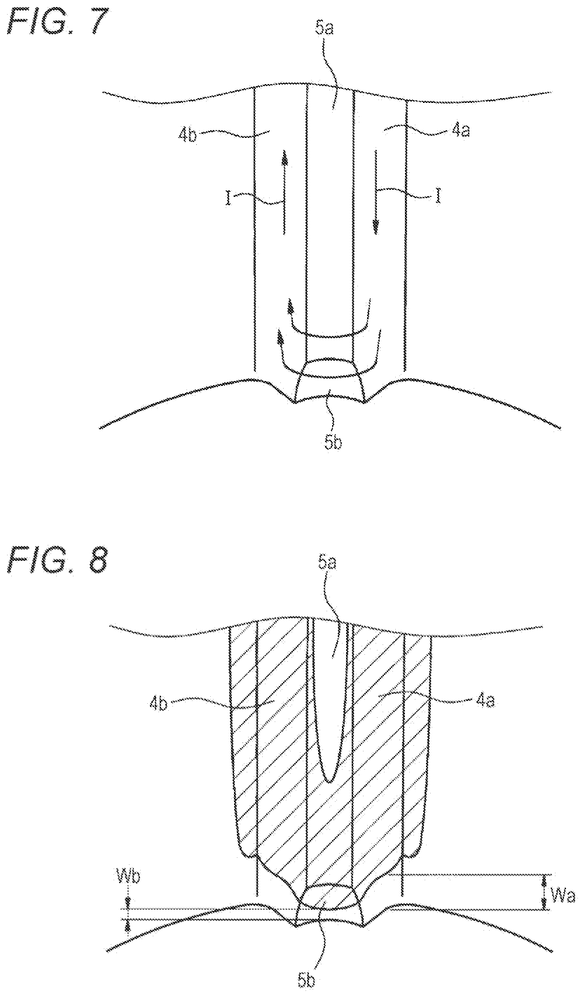

FIG. 7 shows the induction current flowing through the outer ring 2 that is subjected to induction heating by the heating coil 101, and FIG. 8 shows a quenching pattern of the outer ring 2. In FIG. 8, the hatched region indicates a quenched region.

When a high-frequency current is supplied from the power source to the coil body 110, an induction current I flows through the inner peripheral surface of the outer ring 2. The induction current I basically flows along the first heating conductor 120, the second heating conductor 121, and the bridge conductor 122 of each of the heaters 112A, 112B, and 112C, and flows through the both side surfaces 4a and 4b of the roller guide groove 4 in the extending direction of the roller guide groove 4. At the opening side end of the outer ring 2, the induction current I flows across the surface 5a of the protrusion 5 from the side surface 4a (or the side surface 4b ) to the side surface 4b (or the side surface 4a ) adjacent to each other circumferentially sandwiching the protrusion 5.

Here, the first heating conductor 120 and the second heating conductor 121 are shorter than the roller guide groove 4 of the outer ring 2, and the first connection conductor 123 and the second connection conductor 124 are disposed to face each other at the opening side end parts of the both side surfaces 4a and 4b of the roller guide groove 4. As described above, the circumferential interval D1 between the first connection conductor 123 and the second connection conductor 124 is set larger than the circumferential interval D2 between the first heating conductor 120 and the second heating conductor 121 (see FIG. 6). Therefore, the coil gap between the both side surfaces 4a and 4b and the coil body 110 is relatively expanded at the opening side end of the both side surfaces 4a and 4b. Furthermore, the shield member 111 is disposed to face the chamfer surface 5b, which is the opening side end of the surface 5a of the protrusion 5. Therefore, the magnetic field at the opening side end of the both side surfaces 4a and 4b and the chamfer surface 5b is attenuated, and the temperature rise of the opening side end of both side surfaces 4a and 4b and the chamfer surface 5b is suppressed. Due to this, as shown in FIG. 8, the opening side end of the both side surfaces 4a and 4b and the chamfer surface 5b are each provided with an unquenched region extending to the opening end surface 2a of the outer ring 2.

Furthermore, since the circumferential interval D1 between the first connection conductor 123 and the second connection conductor 124 is set relatively large, the shield member 111 disposed between the first connection conductor 123 and the second connection conductor 124 can be made large. This can increase the temperature rise suppression effect of the chamfer surface 5b and the like based on the shield member 111. The induction current also flows through in the shield member 111 disposed close to the coil body 110, and the heat capacity of the shield member 111 can be increased to avoid the erosion of the shield member 111.

A quenching relief width Wa from the opening end surface 2a of the unquenched region provided at the opening side end of the both side surfaces 4a and 4b of the roller guide groove 4 and a quenching relief width Wb from the opening end surface 2a of the unquenched region provided at the chamfer surface 5b of the protrusion 5 can be adjusted based on the distance between the shield member 111 and the chamfer surface 5b. The distance between the shield member 111 and the chamfer surface 5b can be changed depending on the thickness of the spacer 115 interposed between the shield member 111 and the support 114. Due to this, it is not only possible to appropriately adjust the quenching relief width Wa of the both side surfaces 4a and 4b in accordance with the specifications of quenching, but also possible to use the common heating coil 101 for the outer ring 2 having different lengths of the roller guide grooves 4.

The material of the shield member 111 may be a magnetic metal material such as steel or may be a non-magnetic metal material such as copper, but it is preferably a non-magnetic metal material from the viewpoint of avoiding excessive suppression of temperature rise of the chamfer surface 5b or the like.

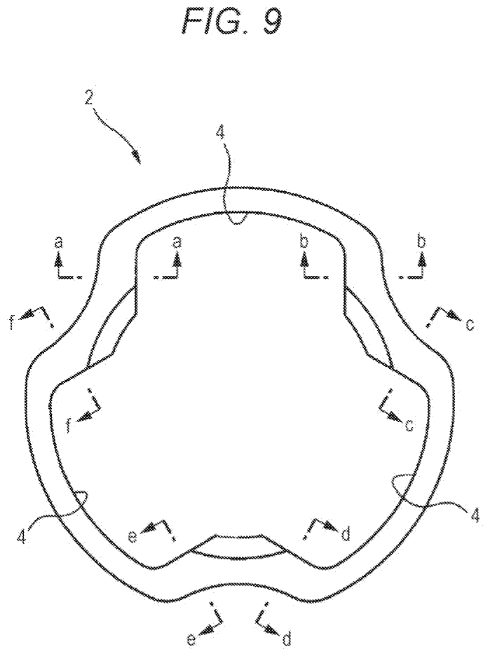

An experiment example will be described below. FIG. 9 shows the outer ring 2 of an experiment example.

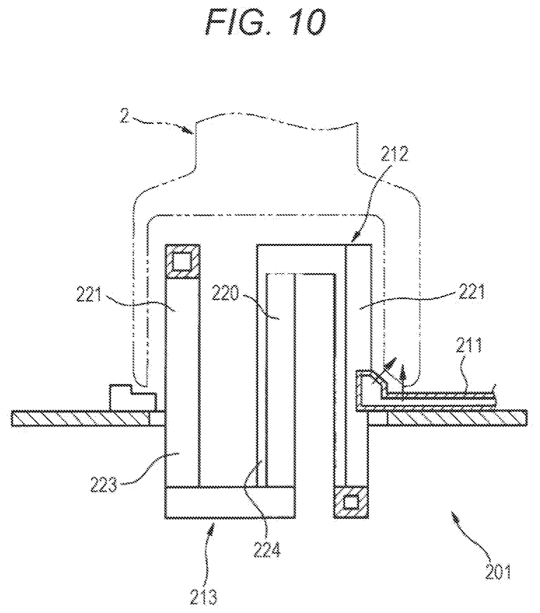

In the experiment example, quenching of the both side surfaces 4a and 4b was performed by setting the quenching relief width Wa of the unquenched region provided at the opening side end of the both side surfaces 4a and 4b of the roller guide groove 4 to equal to or greater than 4 mm to equal to or less than 7 mm. The quenched outer ring 2 was cut at the cut surfaces a to f shown in FIG. 9, and the quenching relief width Wa was measured at each cut surface. In the experiment examples 1 to 11, quenching was performed using a heating coil 201 shown in FIG. 10, and in the experiment examples 12 to 14, quenching was performed using the heating coil 101 described above.

Here, referring to the heating coil 201 shown in FIG. 10, the heating coil 201 includes a coil body 210, and the coil body 210, similarly to the coil body 110 of the heating coil 101, includes three heaters 212 and three connectors 213. However, the circumferential interval (D1 shown in FIG. 6) between a first connection conductor 223 and a second connection conductor 224 of the connector 213 is set to be identical to the circumferential interval (D2 shown in FIG. 6) between a first heating conductor 220 of one heater 212 and a second heating conductor 221 of the other heater 212 of the circumferentially adjacent two heaters 212. The heating coil 201 includes a chamfer cooling jacket 211 in place of the shield member 111 of the heating coil 101, and the chamfer cooling jacket 211 injects a cooling liquid onto the chamfer surface 5b of the protrusion 5 and the opening end surface 2a of the outer ring 2.

The measurement results of the experiment examples 1 to 11 are shown in Table 1, and the measurement results of the experiment examples 12 to 14 are shown in Table 2.

TABLE 1

| Experiment | Quenching relief width Wa [mm] | | | | | |
|---|---|---|---|---|---|---|
| examples | Cut surface a | Cut surface b | Cut surface c | Cut surface d | Cut surface e | Cut surface f |
| No. 1 | 4.5 | 4.0 | 5.0 | 3.0 | 3.8 | 4.8 |
| No. 2 | 3.4 | 3.9 | 3.5 | 4.3 | 4.2 | 2.7 |
| No. 3 | 4.6 | 4.8 | 3.0 | 4.9 | 4.7 | 3.5 |
| No. 4 | 3.5 | 3.6 | 3.2 | 4.5 | 3.0 | 3.9 |
| No. 5 | 3.9 | 5.5 | 3.9 | 5.0 | 4.2 | 3.2 |
| No. 6 | 4.4 | 6.1 | 4.0 | 4.8 | 5.4 | 3.7 |
| No. 7 | 4.7 | 4.8 | 3.3 | 4.5 | 4.7 | 2.9 |
| No. 8 | 3.2 | 5.4 | 3.1 | 4.6 | 5.2 | 5.3 |
| No. 9 | 3.8 | 4.9 | 4.3 | 4.9 | 4.2 | 3.2 |
| No. 10 | 4.2 | 4.7 | 5.8 | 5.9 | 6.1 | 2.8 |
| No. 11 | 4.6 | 5.9 | 3.8 | 4.8 | 6.7 | 3.1 |

TABLE 2

| Experiment | Quenching relief width Wa [mm] | | | | | |
|---|---|---|---|---|---|---|
| examples | Cut surface a | Cut surface b | Cut surface c | Cut surface d | Cut surface e | Cut surface f |
| No. 12 | 6.5 | 6.0 | 6.0 | 5.5 | 6.5 | 6.3 |
| No. 13 | 6.5 | 6.0 | 6.0 | 6.0 | 6.5 | 6.0 |
| No. 14 | 7.0 | 7.0 | 6.5 | 6.8 | 6.5 | 7.0 |

For the specifications of the quenching relief width Wa of equal to or greater than 4 mm to equal to or less than 7 mm, in the experiment examples 1 to 11, where D1=D2 was set and the quenching was performed by using the heating coil 201 suppressing the temperature rise of the chamfer surface 5b by injecting the cooling liquid, the quenching relief width Wa was out of the range of the above specifications at one or more cut surfaces in every example. On the other hand, in the experiment examples 12 to 14, where D1 >D2 was set and the quenching was performed by using the heating coil 101 suppressing the temperature rise of the chamfer surface 5b by the shield member 111, the quenching relief width Wa was within the range of the above specifications in all the cut surfaces in every example. The above results indicate that according to the heating coil 101, an unquenched region can be stably formed at the opening side end of the both side surfaces 4a and 4b of the roller guide groove 4.

As described above, the heating coil disclosed in the present description is a heating coil used for induction heating of a roller guide groove formed on an inner peripheral surface of an outer ring of a tripod type constant velocity joint, including: a coil body inserted into the outer ring through an opening on one end side of the outer ring; and a plurality of shield members disposed to face an inner peripheral surface of an opening side end of the outer ring, wherein the coil body includes three heaters that are disposed at intervals in a circumferential direction around a central axis and each housed in the roller guide groove, and three connectors that are interposed between the two heaters adjacent to each other in the circumferential direction and project from the opening of the outer ring, the three connectors connecting the three heaters in series with a power source, the heater has a first heating conductor and a second heating conductor disposed to face each other on both side surfaces of the roller guide groove, which are a pair of heating conductors extending along the central axis, the connector has a first connection conductor extending from the second heating conductor of one heater of the two heaters adjacent to each other in the circumferential direction and a second connection conductor extending from the first heating conductor of the other heater, which are a pair of connection conductors extending along the central axis, the shield member is provided for each of the connectors, and is disposed between the first connection conductor and the second connection conductor of the connector, and a circumferential interval between the first connection conductor and the second connection conductor of the connector is larger than a circumferential interval between the second heating conductor of one heater of the two heaters adjacent to each other in the circumferential direction and the first heating conductor of the other heater.

The heating coil disclosed in the present description includes a support that supports the coil body and the shield member, and the shield member is supported by the support so as to be displaceable along the central axis between the first connection conductor and the second connection conductor of the connector.

In the heating coil disclosed in the present description, the shield member is made of a non-magnetic metal material.

The quenching device disclosed in the present description includes the heating coil and a cooling jacket that injects a cooling jacket that injects a cooling liquid onto an inner peripheral surface of the outer ring in which the roller guide groove is subjected to induction heating by the heater of the heating coil, and the roller guide groove is subjected to induction heating in a state where a positional relationship between the heating coil and the outer ring is fixed.

What is claimed is:

1. A heating coil used for induction heating of a roller guide groove formed on an inner peripheral surface of an outer ring of a tripod type constant velocity joint, comprising:
a coil body inserted into the outer ring through an opening on one end side of the outer ring; and
a plurality of shield members disposed to face an inner peripheral surface of an opening side end of the outer ring, wherein
the coil body includes
three heaters that are disposed at intervals in a circumferential direction around a central axis and each housed in the roller guide groove, and
three connectors that are interposed between the two heaters adjacent to each other in the circumferential direction and project from the opening of the outer ring, the three connectors connecting the three heaters in series with a power supply,
the heater has a first heating conductor and a second heating conductor disposed to face each other on both side surfaces of the roller guide groove, which are a pair of heating conductors extending along the central axis,
the connector has a first connection conductor extending from the second heating conductor of one heater of the two heaters adjacent to each other in the circumferential direction, and a second connection conductor extending from the first heating conductor of another heater, which are a pair of connection conductors extending along the central axis,
the shield member is provided for each of the connectors, and is disposed between the first connection conductor and the second connection conductor of the connector, and
a circumferential distance between the first connection conductor and the second connection conductor of the connector is larger than a circumferential distance between the second heating conductor of one heater of the two heaters adjacent to each other in the circumferential direction and the first heating conductor of another heater.

2. The heating coil according to claim 1 comprising:
a support that supports the coil body and the shield member, wherein
the shield member is supported by the support so as to be displaceable along the central axis between the first connection conductor and the second connection conductor of the connector.

3. The heating coil according to claim 1, wherein
the shield member is made of a non-magnetic metal material.

4. A quenching device comprising:
the heating coil according to claim 1; and
a cooling jacket that injects a cooling liquid onto an inner peripheral surface of the outer ring in which the roller guide groove is subjected to induction heating by the heater of the heating coil, wherein
the roller guide groove is subjected to induction heating in a state where a positional relationship between the heating coil and the outer ring is fixed.
